(19) United States
(12) Patent Application Publication
(10) Pub. No.: US 2007/0211305 A1
(43) Pub. Date: Sep. 13, 2007

(54) Image forming apparatus and data management apparatus

(75) Inventor: Mio Tanida, Hiratsuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/490,398

(22) Filed: Jul. 21, 2006

(30) Foreign Application Priority Data
Mar. 7, 2006 (JP) JP2006-060576

(51) Int. Cl. H04N 1/40

(52) U.S. Cl. 358/448

(57) ABSTRACT

There is described an image forming apparatus and a data management device, which make it possible to suppress the injustice use of the outputted recording medium, without employing the special paper sheet onto which the ID is attached in advance. The image forming apparatus for outputting an image, connected with the data management device, includes: a data file obtaining section to obtain a data file from the data management device; an image forming section to form an image on a recording medium based on the data file; an identification information generating section to generate identification information corresponding to each recording medium, when the image is formed on the recording medium; and a transmitting section to transmit the identification information corresponding to the recording medium, an output of which is completed, to the data management device.

### RELATED APPLICATION

This application is based on Japanese Patent Application No. 2006-060576 filed on Mar. 7, 2006 in Japanese Patent Office, the entire content of which is hereby incorporated by reference.

### BACKGROUND

1. Field of the Invention

The present invention relates to a data management apparatus that conducts controlling operations of documents stored in it and an image forming apparatus that conducts printing operations of the documents based on image data stored in the data controlling terminal device, and specifically relates to a technology for preventing injustice usage of the printed documents.

2. Description of the Related Art

The document data ranked in a high level of secrecy have been protected from injustice or unauthorized access possibly committed by a third party, for instance, by employing an encryption technology and/or a password. Further, when printing such the document of high secrecy, the characters of “Top Secret” or “Secret” have been also printed on the paper sheet, in order to draw user's attention to the handling of the document concerned.

However, even if such the security countermeasures as mentioned in the above are applied to the document, the security protection of the printed document depends on the responsibility of the personnel who handle the printed document. Therefore, there has been a fear that someone else would illegally utilize the printed document due to a careless management of the document.

Accordingly, in order to secure the security of the printed document, such as where the printed document exist, whether or not the document to be destroyed are correctly disposed, etc., for instance, Patent Document 1 (Tokkai 2005-190365, Japanese Non-Examined Patent Publication) sets forth a managing technology for printing the document on a recording paper sheet to which an Identification (hereinafter, referred to as an ID) is added in advance, and storing both the ID of the recording paper employed for printing and the document ID into the output history database.

Further, Patent Document 2 (Tokkai 2000-159410, Japanese Non-Examined Patent Publication) sets forth a paper classification apparatus that determines whether or not a specific mark, such as “Top Secret”, “Secret”, etc., is attached to the printed recording paper sheet by employing the image analysis when classifying the document into either a reusable document or a non-reusable document. And, the apparatus determines that the recording paper to which the specific mark is attached is the non-reusable document, and cuts the paper into peaces so as to prevent the injustice usage of the non-reusable document.

According to the technology set forth in Patent Document 1 (Tokkai 2005-190365, Japanese Non-Examined Patent Publication), there have been such the problems that it is necessary to employ a special paper sheet on which an ID is attached in advance, and in addition, when a paper sheet, having an IC (Integrated Circuit) tag in which an ID is stored, is employed, a specific reading device for confirming the ID, etc.

Further, since all IDs of the paper sheets failed in output operation are stored as destroying information, an available capacity of the database would be gradually reduced according as the operation period has elapsed, resulting in a possible deterioration of the retrieving velocity.

Still further, according to the paper classification apparatus set forth in Patent Document 2 (Tokkai 2000-159410, Japanese Non-Examined Patent Publication), although the security in the phase of reusing the paper sheet can be secured, the security problem during the period from the time of printing to the time of reusing still remains unsolved. Yet further, in almost of all cases, the paper sheet suffered by an error, which could be repaired only by manual handling at the time of printing, such as a paper jamming, etc., would not be classified into the reusable category due to “tears” and/or “wrinkles”. Accordingly, it has been impossible for the paper classification apparatus set forth in Patent Document 2 to prevent the injustice usage of the paper sheets failed in output operation.

### SUMMARY

To overcome the abovementioned drawbacks in conventional image forming apparatus and data controlling terminal devices, it is an object of the present invention to provide an image forming apparatus and a data controlling terminal device (hereinafter, also referred to as a data management apparatus), which make it possible to suppress the injustice use of the outputted recording medium, without employing the special paper sheet onto which the ID is attached in advance.

Further, it is another object of the present invention to provide an image forming apparatus and a data controlling terminal device, which makes it possible to reduce the amount of data to be stored as the output history at a level lower than ever.

In view of foregoing, an object of this invention is to solve at least one of the problems, and to provide a new image forming apparatus and data management apparatus.

The image forming apparatus for outputting an image, connected with a data management device, comprises a data file obtaining section to obtain a data file from the data management device; an image forming section to form an image on a recording medium based on the data file; an identification information generating section to generate identification information corresponding to each recording medium, when the image is formed on the recording medium; and a transmitting section to transmit the identification information corresponding to the recording medium, an output of which is completed, to the data management device.

According to another aspect of the present invention, the data management apparatus connected with an image forming device for outputting an image, comprises a data file transmitting section to transmit a data file to the image forming device; an identification information receiving section to receive identification information corresponding to each recording medium, each output of the recording medium where the image is formed based on the data file is completed; and a storing section to store the identification information.

The invention itself, together with further objects and attendant advantages, will best be understood by reference to the following detailed description taken in conjunction with the accompanying drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a system configuration of a document controlling system embodied in the present invention, which includes an image forming apparatus and a data controlling terminal device;

FIG. 2 shows an electrical configuration of a multi function peripheral as an example of an image forming apparatus embodied in the present invention;

FIG. 3 shows a functional configuration of a document controlling server in a data controlling terminal device;

FIG. 4 shows an example of information registered in a database;

FIG. 5 shows a flow of outputting operations of documents when the documents are outputted normally;

FIG. 6 shows an example of a correlating relationship between a generation of paper sheet IDs and a state of attaching the paper sheet ID to each of paper sheets, when an output operation for all of the paper sheets results in a success;

FIG. 7 shows a flow of outputting operations of documents when an error occurs;

FIG. 8 shows an example of a correlating relationship between generation of paper sheet IDs, regeneration of the paper sheet ID and a state of attaching the paper sheet ID to each of paper sheets, when an output operation of the paper sheet results in a failure;

FIG. 9 shows a flow of outputting operations of documents when an output operation is suspended;

FIG. 10 shows a flow of operations to be conducted by the user when printing a document;

FIG. 11 shows a flow of operations to be conducted by an authenticating server;

FIG. 12 shows a flow of operations to be conducted by a document controlling server;

FIG. 13 shows a flow of operations to be conducted by an image forming apparatus; and

FIG. 14 shows a flow of operations to be conducted by a document controlling server in such a case that it receives an inquiry in regard to a registration of a paper sheet ID.

### DETAILED DESCRIPTION OF THE PREFERRED EMBODIMENT

Referring to the drawings, the embodiment of the present invention will be detailed in the following.

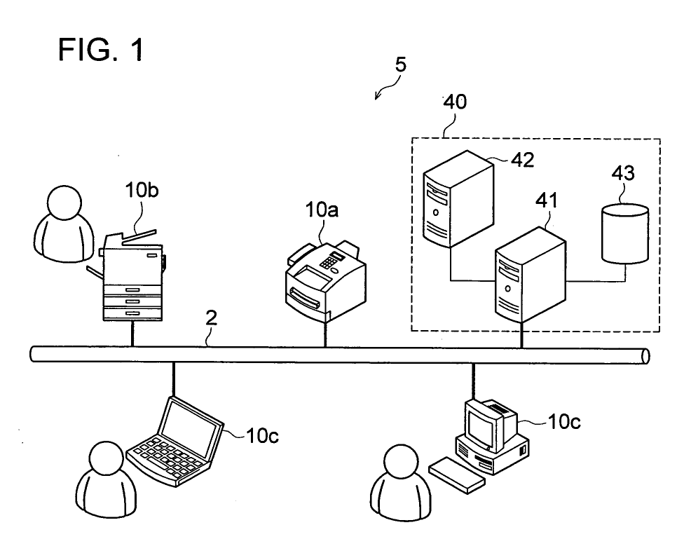

FIG. 1 shows a system configuration of a document controlling system 5 embodied in the present invention, which includes an image forming apparatus 10 and a data controlling terminal device 40. The document controlling system 5 is constituted by the data controlling terminal device 40 for storing a data file of the document, and for totally controlling access information and output information in regard to the stored document, arbitral number of image forming apparatuses 10a, 10b, 10c, - - - , for conducting image forming operations based on the data file acquired by accessing to the data controlling terminal device 40. The data controlling terminal device 40 and the image forming apparatus 10 are connected to each other via a network 2. Any kind of network, such as, for instance, a LAN (Local Area Network), a WAN (Wide Area Network), a WWW (World Wide Web), etc., can be employed as the network 2.

An apparatus merely capable of forming image on a recording medium based on the data file acquired by accessing to the data controlling terminal device 40 can be employed as the image forming apparatus 10. Accordingly, other than a printing apparatus 10a and a multi function peripheral 10b, a computer 10c capable of outputting the document by using the printing apparatus 10a or the multi function peripheral 10b is also applicable as the image forming apparatus 10.

The data controlling terminal device 40 is constituted by a document controlling server 41, an authenticating server 42 and a database 43 serving as a storage section. The user can access to the authenticating server 42 and the document controlling server 41 through an arbitral terminal device or the image forming apparatus 10 coupled to the network. The authenticating server 42 has an authenticating function for conducting the authenticate processing of the user who accesses to it. The document controlling server 41 totally controls the documents, namely, stores the access information and the output information into the database 43 to control them.

Each of the document controlling server 41 and the authenticating server 42 is constituted by a computer having a function for communicating with the image forming apparatus 10 through the network 2, predetermined control programs to be executed by the computer, etc. The database 43 is constituted by a nonvolatile mass storage, such as a HDD (Hard Disc Drive), etc., and a database program. The document controlling server 41, the authenticating server 42 and the database 43 can be either constructed as an integrated apparatus or disposed separately on the network 2.

In the document controlling system 5, when the image forming operation is conducted on the basis of the data file acquired from the data controlling terminal device 40, the image forming apparatus 10 allots an inherent (individual) identification code (hereinafter, referred to as a paper sheet ID) to the recording medium on which an image is to be formed (hereinafter, referred to as a paper sheet), and at the same time, transmits the paper sheet ID of the paper sheet, whose output operations (including processing of image-forming operation, post processing of the paper sheet, paper eject processing, etc.) are completed, to the data controlling terminal device 40 to register it. Then, the paper sheet having the paper sheet ID registered at the data controlling terminal device 40 is handled as a formal one printed in a legal procedure, while the paper sheet whose ID is not registered at the data controlling terminal device 40 is handled as an injustice one.

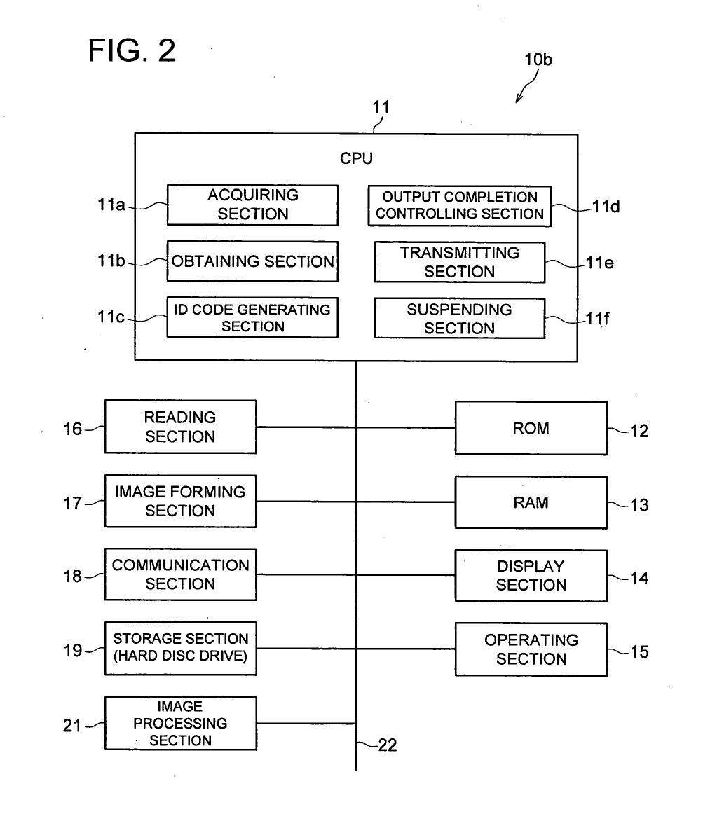

FIG. 2 shows an electrical configuration of the multi function peripheral 10b as an example of the image forming apparatus 10. The multi function peripheral 10b is provided with a copy function, a scanner function, a printer function, a facsimile function, etc., and is constituted by a CPU (Central Processing Unit) 11, a ROM (Read Only Memory) 12, a RAM (Random Access Memory) 13, a display section 14, an operating section 15, a reading section 16, an image forming section 17, a communication section 18, a storage section 19, an image processing section 21 and a bus 22 for coupling them to each other.

The CPU 11 has functions for controlling the overall operations of the multi function peripheral 10b. The ROM 12 serves as a read only memory in which various kinds of programs are stored in advance, while the RAM 13 serves as a work memory in which various kinds of data are temporarily stored and an image memory in which image data are stored when the CPU 11 executes the programs stored in the ROM 12.

The display section 14 is constituted by a liquid crystal display, etc., so as to display various kinds of screens for the purpose of the user interface, such as setting screens, operating screens, etc. The operating section 15 is constituted by a touch panel mounted on the liquid crystal display, operation switches, etc., so as to accept the operating actions conducted by the user.

The reading section 16 has functions of optically reading the image of the original document and outputting the image data corresponding to the image. The reading section 16 is constituted by a line image sensor, etc.

The image forming section 17 has a function for forming the image based on the image data on the paper sheet. In this embodiment, the image forming section 17 is configured as a laser printer provided with a conveyance device of the paper sheet, a photoreceptor drum, a charging device, a laser unit, a developing device, a transferring and separating device, a cleaning device and a fixing device, so as to form an image through an electro-photographic process.

The communication section 18 has a function for communicating various kinds of signals and data with the data controlling terminal device 40 and other external devices through the network 2.

The storage section 19 serves as a storage device for storing the image data read by the reading section 16 and/or the data file received from the data controlling terminal device 40 in it. For instance, the nonvolatile mass storage, such as the HDD, etc., is employed for the storage section 19.

The image processing section 21 has functions for applying various kinds of image processing operations, such as an enlarging processing, a reduction processing, a rotation processing, a compression processing, an expansion processing, etc., to the image data.

The CPU 11 executes various kinds of predetermined programs stored in the ROM 12, in order to serve as an acquiring section 11a, an obtaining section 11b, an ID code generating section 11c, an output completion controlling section 11d, a transmitting section 11e and a suspending section 11f.

The acquiring section 11a conducts a sequence of controlling operations with respect to the acquisition of the output password to be utilized at the time when obtaining the data file from the data controlling terminal device 40. Concretely speaking, the user authenticating operation is conducted by inquiring the authenticate information, inputted by the user, from the authenticating server 42, and when the user authenticating operation is completed as a success, the list of documents output-allowable for the user is received from the document controlling server 41. Further, after accepting the document desired and selected from the list of the documents by the user, the acquiring section 11a requests the document controlling server 41 to output the selected document concerned. Then, as a response for the above request, the acquiring section 11a receives the output password for obtaining the data file of the document concerned.

The obtaining section 11b conducts controlling operations for transmitting the output password acquired by the acquiring section 11a to the data controlling terminal device 40 and for receiving the data file corresponding to the output password from the data controlling terminal device 40. The ID code generating section 11c has a function for generating an inherent paper sheet ID (identifying information) for every paper sheet on which the image is to be formed, when the image is formed on the paper sheet based on the data file obtained by the obtaining section 11b.

Since the paper sheet ID should be inherent to each of the paper sheets, when a plurality of image forming apparatuses 10 exists in the system, the ID code generating section 11c is controlled so as not to generate a double paper sheet ID among the plurality of the image forming apparatuses 10.

For instance, the data controlling terminal device 40 designates and transmits a row of characters inherent to the current output operation to the image forming apparatus 10, and the ID code generating section 11c of the image forming apparatus 10 generates the paper sheet ID by adding a serial number created in the image forming apparatus 10 side (for instance, a serial number starting from 1 for every job) to the row of characters received. According to this procedure, it is possible to generate the paper sheet IDs without duplication of them. Further, if the output password, acquired at the time when obtaining the data file from the data controlling terminal device 40, is inherent to the current image forming job, it is possible to employ the acquired output password for a part of the paper sheet ID.

The output completion controlling section 11d monitors whether or not the paper ejecting operation of each of the paper sheets is normally completed after the image is formed on it, so as to determine the paper sheet ID of the paper sheet, the paper ejecting operation of which is normally completed, as an effective one. Further, when an output malfunction is detected, the output completion controlling section 11d destroys the paper sheet ID of the paper sheet concerned, and/or controls a generating operation of a new paper sheet ID to be replaced for the paper sheet ID destroyed in the above. The transmitting section 11e conducts controlling operations for transmitting the effective paper sheet ID to the data controlling terminal device 40 every time when the output completion controlling section 11d determines that the paper sheet ID is effective (namely, every time when the paper ejecting operation is normally completed). Incidentally, when transmitting the paper sheet ID, it is applicable that date and time information of the image forming operation and the output password to be employed when outputting the image on the basis of the data file are also transmitted with the paper sheet ID, while correlating them with each other.

The suspending section 11f has a function for accepting an instruction of job suspension sent from the operating section 15 or an external terminal device. When the suspending section 11f accepts the instruction of job suspension, the transmitting section 11e conducts controlling operations for transmitting a delete requesting command, for requesting a delete of the paper sheet ID already transmitted to the data controlling terminal device 40 before the job suspension is activated, to the data controlling terminal device 40. The delete requesting command is transmitted while correlating with the output password.

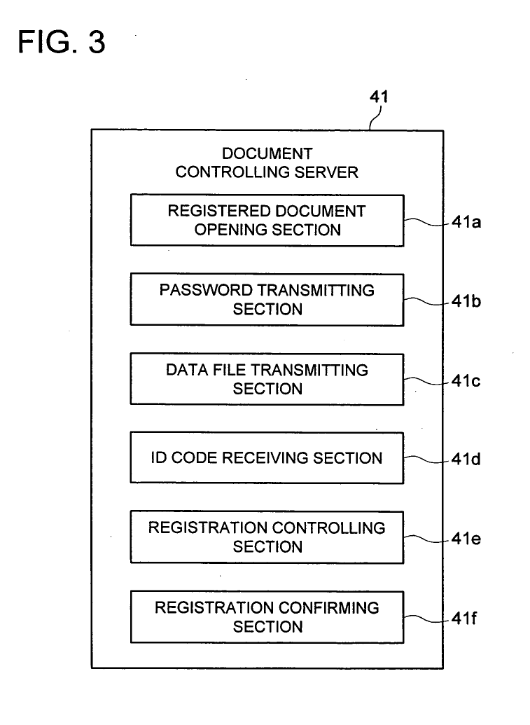

FIG. 3 shows a functional configuration of the document controlling server 41 in the data controlling terminal device 40. As shown in FIG. 3, the document controlling server 41 has functions of a registered document opening section 41a, a password transmitting section 41b, a data file transmitting section 41c, an ID code receiving section 41d, a registration controlling section 41e and a registration confirming section 41f.

When the user authenticating operation conducted in the authenticating server 42 is a success, the registered document opening section 41a transmits the list of the documents output-allowable for the user to the image forming apparatus 10 concerned. Incidentally, the data file of the document is stored in a mass storage device (not shown in the drawings) of the document controlling server 41. In response to the document outputting request sent from the image forming apparatus 10, the password transmitting section 41b returns the output password correlated with the data file of the output-requested document concerned. Further, in response to the reception of the output password sent from the image forming apparatus 10, the data file transmitting section 41c transmits the data file, correlated with the output password concerned, to the image forming apparatus 10 being the original sender of the output password concerned.

The ID code receiving section 41d receives the paper sheet IDs successively sent from the image forming apparatus 10 to store them into the database 43. The registration controlling section 41e controls operations for storing and deleting the paper sheet ID. For instance, in response to the delete requesting command sent from the image forming apparatus 10, the registration controlling section 41e deletes the paper sheet ID concerned from the database 43.

The registration confirming section 41f accepts an inquiry sent from the external terminal device in regard to presence or absence of the registration of the paper sheet ID, in order to investigate whether or not the paper sheet ID concerned to the inquiry is stored in the database 43, and then, returns the result of the investigation to the external terminal device being the sender of the inquiry.

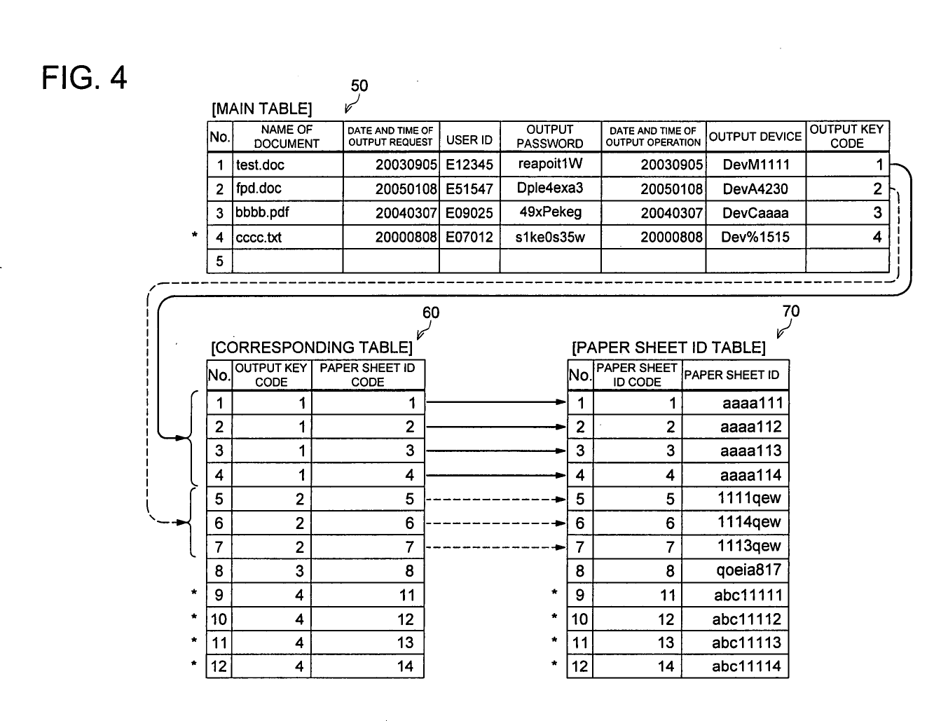

FIG. 4 shows an example of the information registered in the database 43. A main table 50, a corresponding table 60 and a paper sheet ID table 70 are registered in the database 43. In the main table 50, a single horizontal line corresponds to a single outputting operation. Further, a name of document to be outputted (a name of data file), an output-requested date and time, a user ID, an output password already issued, an output date and time, an output device (namely, a device number inherent to the output device, etc.) and an output key code are registered in the main table 50, while correlating them with each other.

The output key code and the paper sheet ID code are correlated with each other and registered in the corresponding table 60, while the paper sheet ID code and the paper sheet ID are correlated with each other and registered in the paper sheet ID table 70. The main table 50 is correlated with the corresponding table 60 by the output key code, while the corresponding table 60 is correlated with the paper sheet ID table 70 by the paper sheet ID code. For instance, it can be readily found that the document name of “test. doc” is correlated with the four paper sheet IDs of “aaaa111”, “aaaa112”, “aaaa113” and “aaaa114”, by tracing the output key code and the paper sheet ID code, and is printed on the four paper sheets having the above paper sheet IDs.

Next, a flow of outputting operations of the documents conducted in the document controlling system 5 will be detailed in the following.

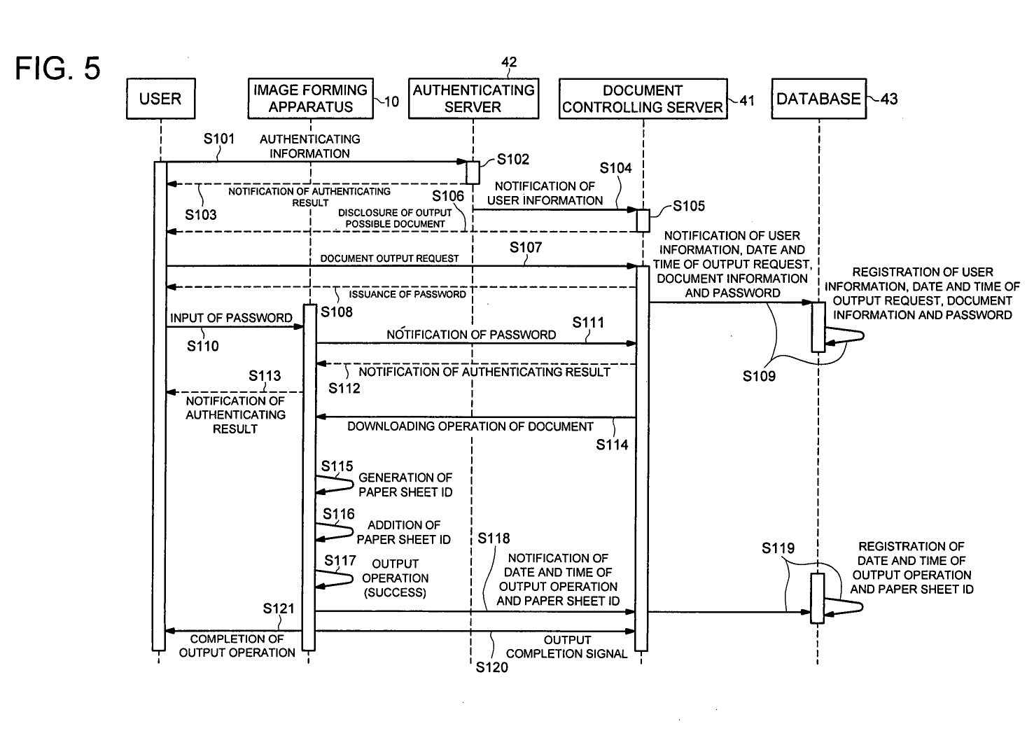

FIG. 5 shows a flow of outputting operations of the documents when the documents are outputted normally. In this flow, it is assumed that the user inputs various kinds of operational commands from the operating section 15 of the multi function peripheral 10b. when the user inputs information to be utilized for the authentication processing, the image forming apparatus 10 transmits the authenticating information inputted by the user to the authenticating server 42 (Step S101). Based on the authenticating information received from the image forming apparatus 10, the authenticating server 42 conducts the user authentication processing (Step S102), and notifies the user of its result (Step S103). The result is notified to the user through, for instance, the display section 14 of the image forming apparatus 10. Further, the authenticating server 42 also transmits the user information of the user whose authentication processing is a success to the document controlling server 41 (Step S104).

The document controlling server 41 retrieves a document, being output-allowable for the user and corresponding to the user information transmitted form the authenticating server 42, form the documents stored in the document controlling server 41 (Step S105), and discloses the information in regard to the retrieved document for the user through the image forming apparatus 10 (Step S106). In this embodiment, the document list, in which the titles of the retrieved documents are listed, is transmitted to the image forming apparatus 10 and is displayed on the display section 14 of the image forming apparatus 10, in order to notify the user of the registration information with respect to the documents being output-allowable for the user. For instance, a document registered with the user name of the user concerned, a document for which the user concerned is registered in the output-allowable user list, etc. corresponds to the documents being output-allowable for the user. What kind of document should be output-allowable could be determined by an appropriate rule for every system.

The user can select a desired document from the documents listed in the document list displayed on the document controlling server 41, and then, the image forming apparatus 10 transmits a command of requesting the output of the selected document to the document controlling server 41 (Step S107).

In response to the abovementioned command transmitted from the image forming apparatus 10, the document controlling server 41 generates an output password for the user to obtain the data file corresponding to the output request, and notifies the user of the output password through the image forming apparatus 10 (Step S108). Further, the document controlling server 41 adds and registers the information in regard to the output request concerned into the main table 50 of the database 43 (Step S109). Concretely speaking, the document controlling server 41 adds a new record area to the main table 50 so as to register the name of the document, the date and time of the output request, the user ID and the output password into the record area newly added.

The user inputs the output password, notified by the document controlling server 41, from the operating section 15 of the image forming apparatus 10 (Step S110). The image forming apparatus 10 notifies the document controlling server 41 of the output password inputted by the user (Step S111). Then, the document controlling server 41 authenticates the output password received from the image forming apparatus 10 (namely, confirming the coincidence with the output password issued), and notifies the image forming apparatus 10 of the authenticated result (Step S112). The image forming apparatus 10 notifies the user of the authenticated result received from the document controlling server 41 (Step S113), and, at the same time, if the authentication of the output password results in a success, downloads the data file of the document correlated to the output password concerned (Step S114).

When the downloading operation of the data file of the document is completed, the image forming apparatus 10 calculates the total number of the paper sheets to be used in the image forming job based on the data file, and, preceding to the image forming operation of them, generates the paper sheet IDs corresponding to the total number of the paper sheets calculated (Step S115).

The image forming apparatus 10 adds any unused one of the generated paper sheet IDs to the paper sheet on which the image is to be formed (Step S116), to print the image based on the data file on it, and outputs the printed paper sheet (Step S117). In this embodiment, a synthesizing operation for synthesizing the paper sheet ID with the image based on the data file is conducted so as to form the paper sheet ID at a predetermined position located in a corner area of the paper sheet, and then, the printing operation is conducted on the basis of the synthesized image data.

When the paper ejecting operation is completed without occurrence of any abnormal defect, such as a paper jamming, etc., and the output operation of the paper sheet on which the image is formed results in a success, the image forming apparatus 10 transmits the paper sheet ID attached to the paper sheet whose paper ejecting operation is completed, the date and time of the output operation and the output password to the document controlling server 41 (Step S118), so that the document controlling server 41 can register the transmitted information into the database 43 (Step S119).

The abovementioned operational steps from Step S116 to Step S119 are repeatedly conducted until the image forming job is completed. In other words, the notifying and registering operations of the paper sheet ID are sequentially conducted every time when the paper ejecting operation of the paper sheet, on which the image is formed, is completed.

When the output operations of all of the paper sheets are completed, the image forming apparatus 10 transmits an output completion signal to the document controlling server 41 (Step S120), and at the same time, notifies-the user of the completion of the output operations. In response to the output completion signal, the document controlling server 41 recognizes the completion of the consecutive output processing.

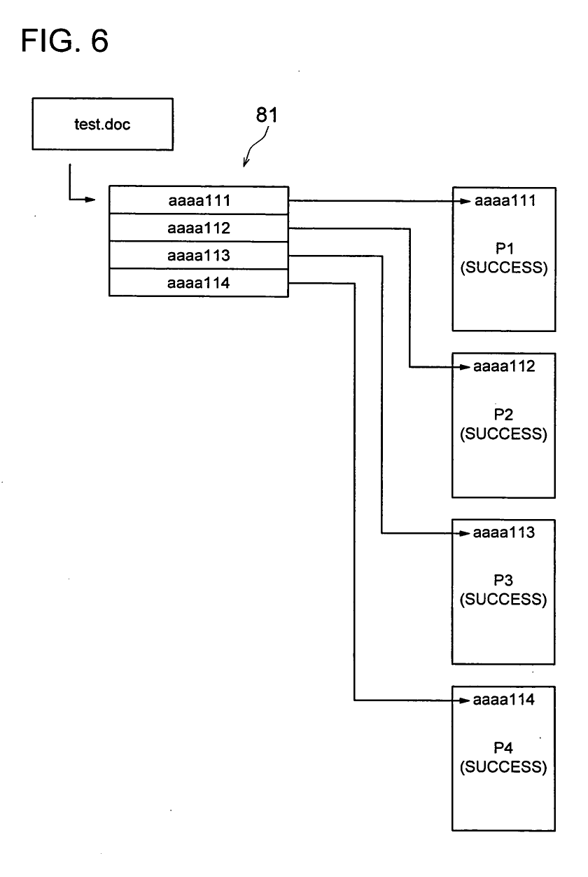

FIG. 6 shows an example of a correlating relationship between the generation of the paper sheet IDs and the state of attaching the paper sheet ID to each of the paper sheets, when the output operation for all of the paper sheets results in a success. According to this example, four paper sheet IDs 81 (including “aaaa111”, “aaaa112”, “aaaa113”, “aaaa114”) are initially generated for four data files “test.doc”, and are respectively allotted to the paper sheets P1-P4 in a state of one by one, to print and output them. The image forming job shown in FIG. 6 corresponds to the record of No. 1 in the main table 50 shown in FIG. 4, while the four paper sheet IDs 81 (including “aaaa111”, “aaaa112”, “aaaa113”, “aaaa114”), received from the image forming apparatus 10, are registered in the records of No. 1-No. 4 of the paper sheet ID table 70.

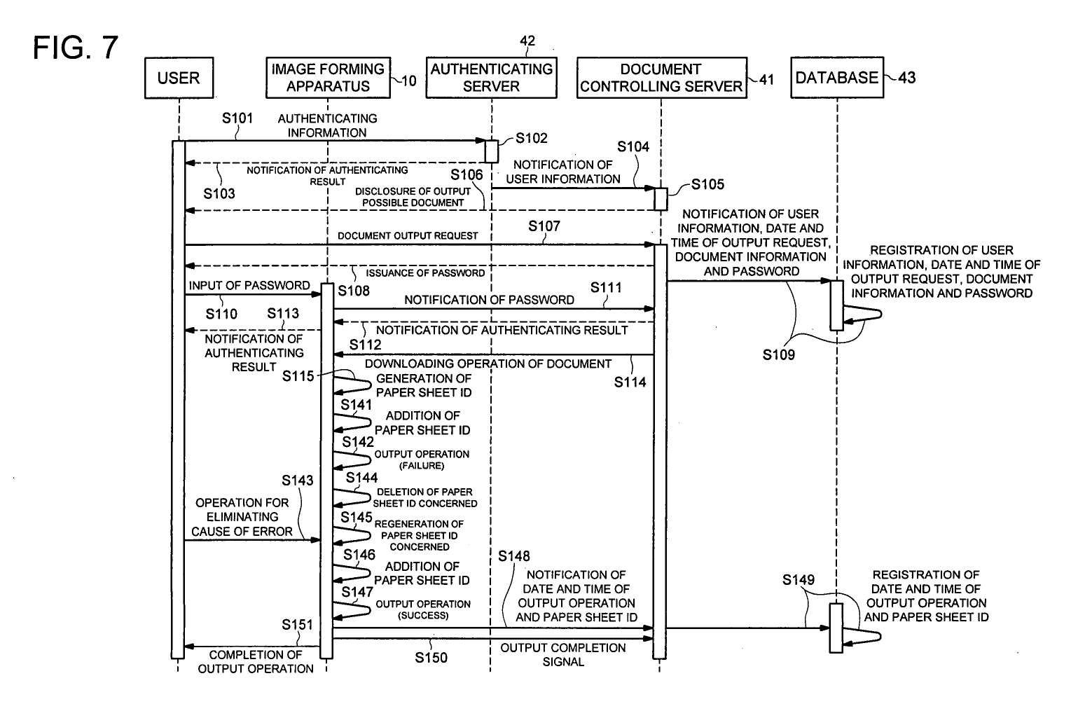

FIG. 7 shows a flow of outputting operations of the documents when an error occurs. Since the processing to be conducted in the operations from Step S101 to Step S115 are the same as those in the FIG. 5, the explanations of them will be omitted. Although the image forming apparatus 10 adds any unused one of the paper sheet IDs for all of the paper sheets, which are initially generated in Step S115, to the paper sheet on which the image is to be formed (Step S141), and printouts them, an error, such as the paper jamming, etc., occurs in the outputting operation (such as the processing for image forming operation, the post processing after the completion of the image forming operation, the paper ejection processing, etc.) of the paper sheet concerned (Step S142).

The user eliminates the cause of the error concerned, by removing the jammed paper, or the like (Step S143). The image forming apparatus 10 destroys the paper sheet ID allotted to the paper sheet in which the error occurs (Step S144), and regenerates a new paper sheet ID as an alternative of the destroyed paper sheet ID (Step S145). The regenerated paper sheet ID is an inherent paper sheet ID, which is different from the destroyed paper sheet ID and does not duplicate with any other paper sheet ID.

This regenerated paper sheet ID is added to a paper sheet, which is to be initially printed just after the recovery from the error (Step S146), and the paper sheet is printed and outputted (Step S147). When the paper ejecting operation of the paper sheet is completed without any occurrence of an abnormality, such as the paper jamming, etc., and the output operation of the paper sheet results in a success, the paper sheet ID added to the ejected paper sheet (namely, the regenerated paper sheet ID), date and time of the output operation and the output password are transmitted to the document controlling server 41 (Step S148) so as to register them into the database 43 (Step S149).

When the output operations of all of the paper sheets are completed, the image forming apparatus 10 transmits an output completion signal to the document controlling server 41 (Step S150), and at the same time, notifies the user of the completion of the output operations (Step S151), so as to finalize the consecutive output operations.

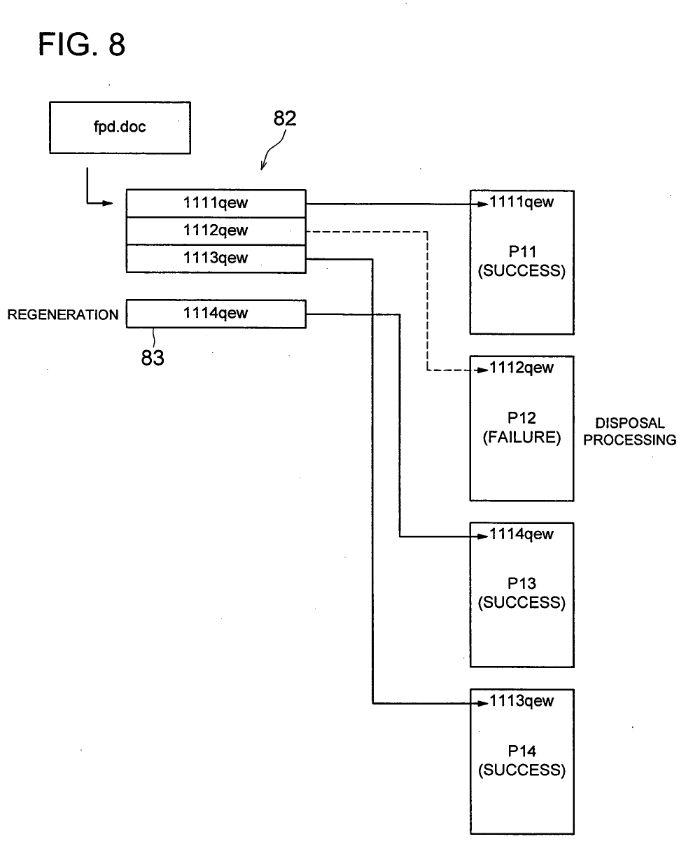

FIG. 8 shows an example of a correlating relationship between the generation of the paper sheet IDs, the regeneration of the paper sheet ID and the state of attaching the paper sheet ID to each of the paper sheets, when the output operation of the paper sheet results in a failure. According to this example, three paper sheet IDs 82 (including “1111qew”, “1112qew”, “1113qew”) are initially generated for three data files “fpd.doc”. The image to be printed on the first page is printed onto the paper sheet P11, to which the paper sheet ID of “1111qew” is attached, and succeeded in the output operation. Although the image to be printed on the second page is printed onto the paper sheet P12, to which the paper sheet ID of “1112qew” is attached, the paper sheet P12 has suffered an error, such as a paper jamming, etc., and failed in the output operation. Accordingly, corresponding to the error, a new paper sheet ID 83 (namely, “1114qew”) is regenerated. The image to be printed on the second page is reprinted onto the paper sheet P13, to which the regenerated paper sheet ID of “1114qew” is attached, and succeeded in the output operation. The image to be printed on the third page is printed onto the paper sheet P14, to which the paper sheet ID of “1113qew” is attached, and succeeded in the output operation.

In the abovementioned case, the paper sheet ID of “1112qew” attached to the paper sheet P12 is destroyed so as not to transmit it to the document controlling server 41, while only the paper sheet IDs (such as “1111qew”, “1114qew”, “1113qew”) of the paper sheets, which succeeded in the output operation, are transmitted to the document controlling server 41. The image forming job shown in FIG. 8 corresponds to the record of No. 2 in the main table 50 shown in FIG. 4, while the three paper sheet IDs (including “1111qew”, “1114qew”, “1113qew”), received from the image forming apparatus 10, are registered in the records of No. 5-No. 7 of the paper sheet ID table 70.

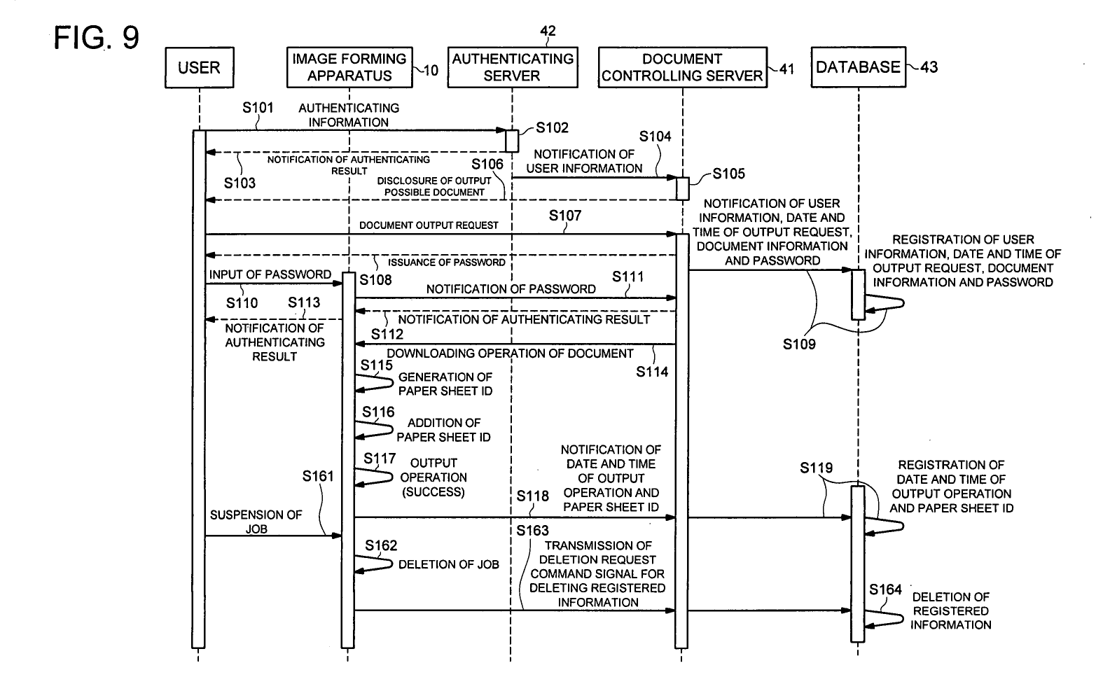

FIG. 9 shows a flow of outputting operations of the documents when the output operation is suspended. Since the processing to be conducted in the operations from Step S101 to Step S119 are the same as those in the FIG. 5, the explanations of them will be omitted. In the example shown in FIG. 9, the output operation for the first paper sheet results in a success (Step S117), and after the paper sheet ID of the first paper sheet is transmitted to the document controlling server 41 to register it into the database 43 (Step S118, Step S119), the image forming apparatus 10 receives an instruction of job suspension from the user (Step S161). Receiving the instruction of job suspension, the image forming apparatus 10 deletes the image forming job concerned (Step S162), and further, transmits a deletion request command signal for requesting the deletion of the paper sheet ID transmitted before the job suspension (Step S163). The deletion request command signal is transmitted with the output password.

In response to the deletion request command signal received from the image forming apparatus 10, the document controlling server 41 deletes the registration items concerned (Step S164). Concretely speaking, based on both the deletion request command signal and the output password received, the document controlling server 41 specifies the registration items to be deleted, so as to delete the concerned records from the main table 50, the corresponding table 60 and the paper sheet ID table 70, respectively. For instance, when the document controlling server 41 receives the deletion request command signal in a mid-course of implementing the image forming job in regard to the record of No. 4 in the main table 50 shown in FIG. 4, the document controlling server 41 will delete the record of No. 4 in the main table 50, the records of No. 9-No. 12 in the corresponding table 60 and the records of No. 9-No. 12 in the paper sheet ID table 70, which are indicated by mark “*” shown in FIG. 4.

On the security point of view, the paper sheet failed in the output operation or printed before the job suspension should be disposed as a waste material, by nature. However, even if such the paper sheet is utilized for an injustice purpose without being appropriately disposed, the paper sheet ID of the paper sheet failed in the output operation or printed before the job suspension is not registered in the database 43 of the data controlling terminal device 40. Accordingly, in the event of employing the printed paper sheet, when the paper sheet concerned is not registered in the database 43, as a result of inquiring presence or absence of the registration of the paper sheet ID concerned from the data controlling terminal device 40, it is possible to recognize that the paper sheet to which the paper sheet ID concerned is attached should be disposed as a waste material, by nature, but is utilized for the injustice purpose. Therefore, it becomes possible to take an appropriate countermeasure for such the injustice use.

For instance, when selling commercial products through the network, in such the case that a system, in which a ticket for receiving the commercial product is downloaded to print it, and the printed ticket is exchanged for the commercial product at a store, is operated, it becomes possible to prevent the injustice utilization of the ticket, which failed in the printout operation and should be disposed by nature as a waste material, by attaching the paper sheet ID to the ticket to be printed, for controlling purpose. In other words, since the paper sheet ID printed on the injustice ticket to be disposed is not registered in the database 43 of the data controlling terminal device 40, when exchanging the ticket for the commercial product, by inquiring of the data controlling terminal device 40 presence or absence of the registration of the paper sheet ID of the ticket from a terminal device installed at the store, if the answer is absence of the registration, it is possible to find the injustice utilization of the ticket.

Incidentally, it is needless to say that the present invention is also applicable for other securities and print products having commercial values.

Further, since only the paper sheet ID of the paper sheet, which succeeded in the output operation, is registered, the amount of data to be stored in the database 43 is considerably reduced, compared to that in the case that all of data including the history information of failed output operation are stored. Accordingly, it becomes possible to conduct effective controlling operations in regard to the output information.

Next, a flow of operations conducted by the user and each of the apparatuses will be detailed in the following.

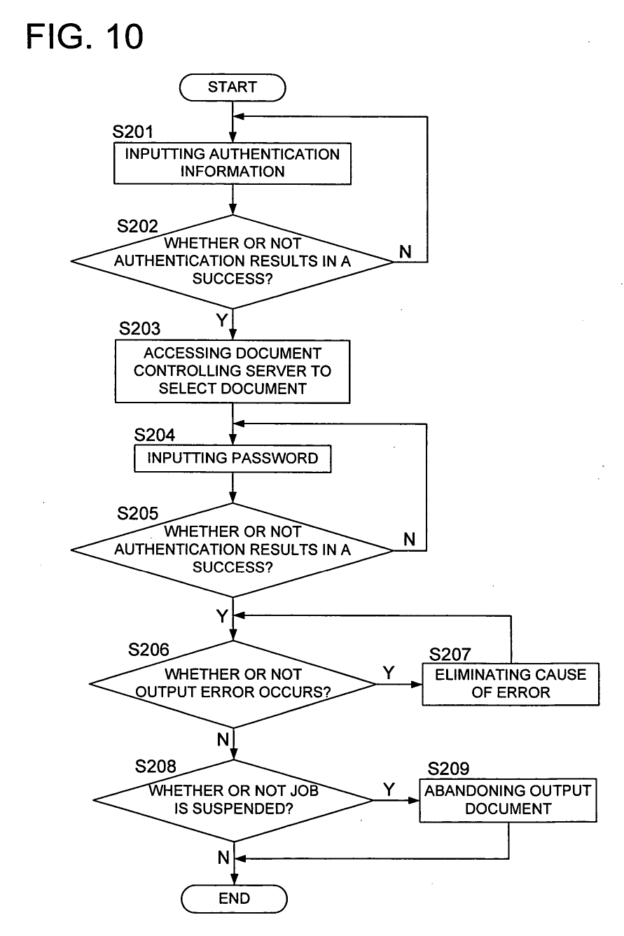

FIG. 10 shows operations to be conducted by the user when printing the document. The flowchart of user's operations shown in FIG. 10 includes the steps of: inputting authenticating information (Step S201); accessing to the document controlling server 41 to acquire the document list, when the authentication results in a success (Step S202, Yes); and selecting a document desired to print form the document list concerned (Step S203). At this time, it becomes possible for the user to view the selected document.

The flowchart of user's operations shown in FIG. 10 further includes the steps of: inputting the output password issued by the document controlling server 41 (Step S204); authenticating the output password inputted by the user by means of the document controlling server 41; printing and outputting the document when the authenticating step results in a success (Step S205, Yes); conducting an operation for removing the cause of an error when the error happen to occur in a mid-course of the output operation, for instance, removing a jammed paper to destroy it when a paper jamming error occurs, etc., (Step S207); and destroying the documents outputted so far, as a waste disposal (Step S208, Yes), when suspending the output operation (suspension of the job concerned) (Step S209).

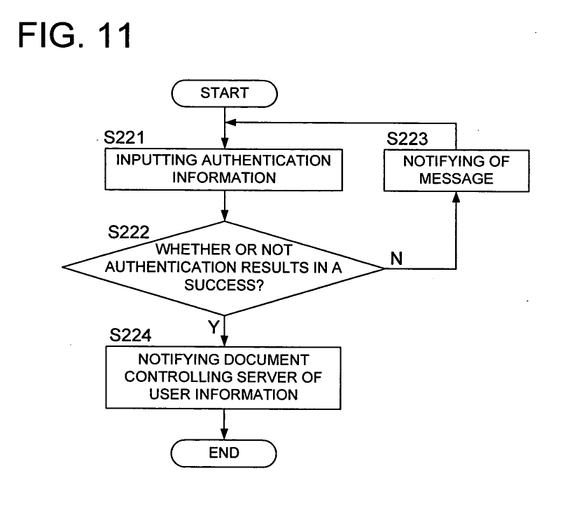

FIG. 11 shows operations to be conducted by the authenticating server 42. The flowchart of the authenticating server 42 shown in FIG. 11 includes the steps of: examining the authentication information received from the user through the multi function peripheral 10b, the computer 10c, etc. (Step S221); notifying the document controlling server 41 of the user information concerned (Step S224) so as to finalize the processing (END), when the authentication results in a success (Step S222, Yes); and notifying the user of an predetermined error message indicating contents of the error (Step S223), when the authentication results in a failure (Step S222, No).

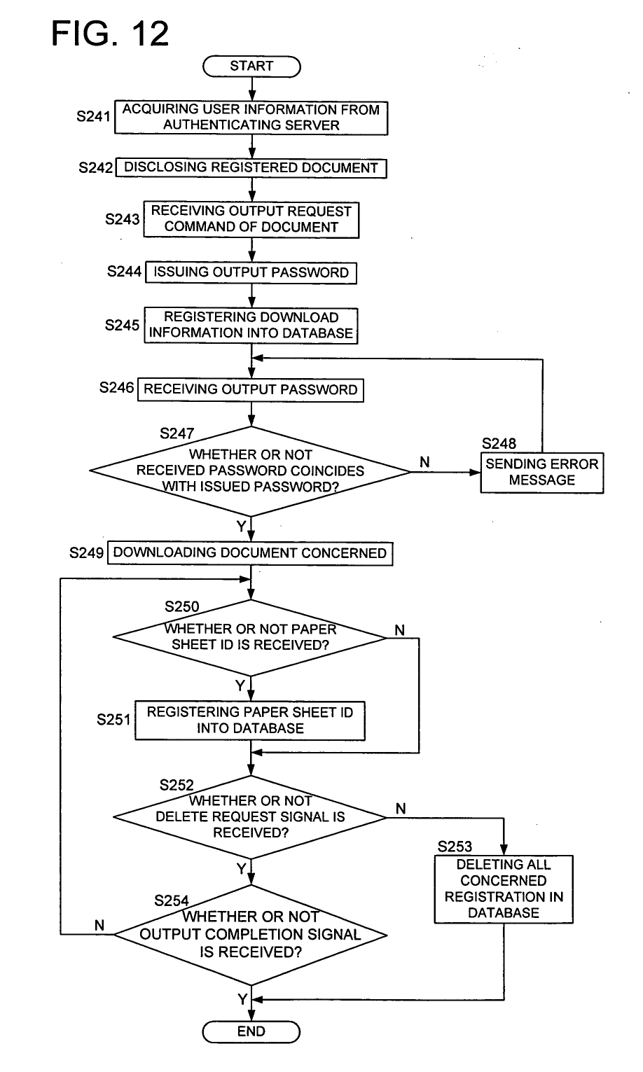

FIG. 12 shows operations to be conducted by the document controlling server 41. The flowchart of the document controlling server 41 shown in FIG. 12 includes the steps of: acquiring the user information from the authenticating server 42 (Step S241); retrieving the document registered corresponding to the user concerned in order to notify the user of its document list (Step S242); receiving the output request command for requesting the document selected from the document list (Step S243); issuing and transmitting the output password for outputting the document in regard to the output request command (Step S244); and registering the information in regard to the document, the information in regard to the accessed user, the generated output password, etc. into the database 43 as additional registration data.

The flowchart of the document controlling server 41 shown in FIG. 12 further includes the steps of: receiving the output password (Step S246) after Step S245; determining whether or not the received output password coincides with the output password already issued (Step S247); sending an error message (Step S248) and returning to the standby state for waiting the reception of the output password (Step S246), when not in Step S247; commencing an operation for downloading the data file of the document concerned (Step S249), when determining that the received output password coincides with the output password already issued (Step S247, Yes); registering the received paper sheet ID into the database 43 (Step S251), when the notification of the paper sheet ID is received (Step S250, Yes); deleting the concerned registration from the database 43 (Step S253), when the delete requesting command is received (Step S252, Yes); and finalizing the processing (END).

The flowchart of the document controlling server 41 shown in FIG. 12 further includes the steps of: returning to Step S250 to continue the processing, when the delete requesting command is not received (Step S252, No) and the output completion signal is not received (Step S254, No); completing the registering operation to the database 43 (Step S251), when the output completion signal is received (Step S254, Yes); and finalizing the processing (END).

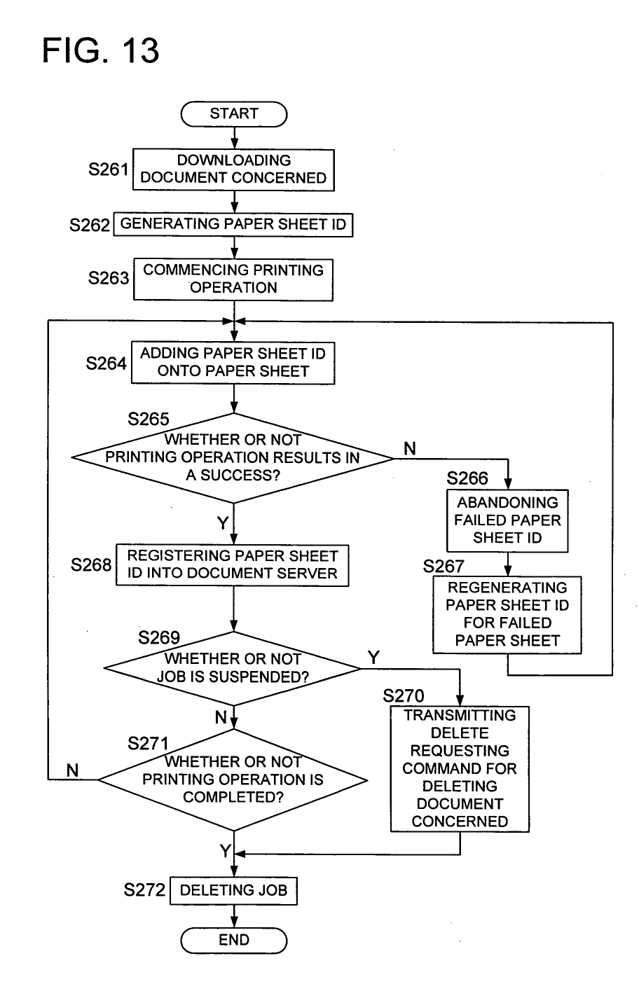

FIG. 13 shows operations to be conducted by the image forming apparatus 10. The flowchart of the image forming apparatus 10 shown in FIG. 13 includes the steps of: downloading the data file of the document selected by the user (Step S261); and initially generating the paper sheet IDs to be attached to each of the paper sheets when printing the images in regard to the data file (Step S262). The abovementioned paper sheet IDs are generated for a number of paper sheets to be printed.

The flowchart of the image forming apparatus 10 shown in FIG. 13 further includes the steps of: conducting the printing operation of a paper sheet, being one of the paper sheets to be printed, by attaching any unused one of the generated paper sheet IDs onto the paper sheet (Step S264); destroying the paper sheet ID attached to the paper sheet (Step S266), when the output operation of the paper sheet results in a failure due to the paper jamming, etc. (Step S265, No); regenerating a new paper sheet ID to be attached to a next paper sheet used for the recovery operation of the failed paper sheet (Step S267); conducting again the printing operation by attaching the regenerated paper sheet ID to the next paper sheet (Step S264); notifying the document controlling server 41 of the paper sheet ID attached to the concerned paper sheet so as to register it into the database 43 (Step S268), when the output operation results in a success (when the paper ejecting operation is completed) (Step S265, Yes); transmitting the delete requesting command for deleting the information with respect to the output operation of the document concerned (Step S270), when the job suspension command is received before completion of the printing operation of the document concerned (Step S269, Yes); deleting the concerned job from the image forming apparatus 10 (Step S272) to finalize the processing (END); investigating whether or not the printing operation in regard to the job concerned is completed (Step S271), when the job suspension command is not received (Step S269, No); returning to Step S264 to continue the printing operation, when not in Step S271; deleting the job concerned (Step S272), when determining that the printing operation of all pages in regard to the job concerned is completed (Step S271, Yes); and finalizing the processing (END).

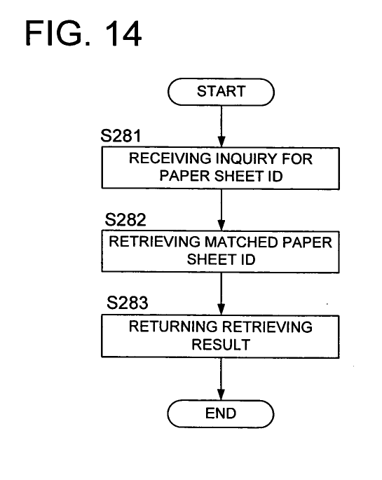

FIG. 14 shows operations to be conducted by the document controlling server 41 in such a case that it receives an inquiry in regard to the registration of the paper sheet ID when using the paper sheet printed on the basis of the data file. The flowchart of the document controlling server 41 shown in FIG. 14 includes the steps of: receiving an inquiry request attached with the paper sheet ID and sent from an arbitral terminal device, such as a computer, etc., (Step S281); retrieving whether or not the paper sheet, which is the same as that concerned to the inquiry request, is already registered (Step S282); and transmitting its retrieving result back to the terminal device of the sender of the inquiry request (Step S283). It is also applicable that, when the paper sheet ID concerned to the inquiry request is already registered, the information correlated to the paper sheet ID concerned, such as the user information, the name of the document, etc., are transmitted to the terminal device of the sender of the inquiry request.

Referring to the drawings, the embodiment of the present invention is described in the foregoing. However, the scope of the present invention is not limited to the embodiment described in the foregoing. Disclosed embodiment can be varied by a skilled person without departing from the spirit and scope of the invention.

For instance, although the image forming apparatus 10 notifies the document controlling server 41 of the paper sheet ID attached to the paper sheet every time when the output operation of the paper sheet results in a success in the abovementioned embodiment, it is also applicable that the image forming apparatus 10 notifies the document controlling server 41 of the paper sheet IDs in a unit of the job concerned (namely, those for a plurality of pages at a time). Concretely speaking, during the implementation of the job, the image forming apparatus 10 stores the paper sheet IDs of the paper sheets, each of which results in a success, in it, and, when the job is normally completed, the paper sheet IDs stored so far in the image forming apparatus 10 are transmitted to the document controlling server 41 at a time, so as to register them in it. This operation for transmitting the paper sheet IDs at a time also serves as a output operation completing signal. Further, with respect to the date and time information and the output password, it is also applicable that those are transmitted in a unit of the job concerned at a time, and are attached in a unit of the job concerned, instead of attached for every recording medium. On the other hand, the paper sheet ID attached to the paper sheet, which is failed in the output operation, is destroyed without included in the objects to be transmitted to the document controlling server 41. Further, when the job is suspended, the image forming apparatus 10 transmits the delete requesting command to the document controlling server 41. In response to the delete requesting command, the document controlling server 41 deletes the information initially registered into the database 43 in regard to the current output operation (those registered in Step S109 shown in FIG. 5).

Still further, although the data file of the document can be downloaded after the output password is authenticated in the abovementioned embodiment, it is also applicable that the present invention is applied to such a system in which the data file of the document can be downloaded in response to the request from the user without conducting the authenticating operation, so as to conduct the operations in regard to the generation, the addition and the registration of the paper sheet ID. Still further, it is also applicable to discriminate whether or not the operations in regard to the generation, the addition and the registration of the paper sheet ID are conducted corresponding to the property of the data file. For instance, other than the properties directly indicating the presence or absence of the protection, such as the ON/OFF of the security protection of the data file itself, the ON/OFF of the security protection of the outputted document, the properties indirectly indicating the presence or absence of the protection, such as the charged/free of the output operation, the presence or absence of the limitations due to the copyright, are also applicable.

When adding the paper sheet ID to the recording medium, other than the method for printing the paper sheet ID by employing characters and symbols, for instance, a method for converting the content of the paper sheet ID to the computer readable coded information, such as a barcode, etc., is also applicable.

Incidentally, it is also applicable that an effective date is established for the output password, so that the output password is controlled to expire in such a case that the downloading operation of the data file correlated to the output password is not conducted until the effective date has elapsed.

According to the image forming apparatus and the data management apparatus embodied in the present invention, the following effects can be attained.

Since the identification information are allotted to every recording medium to be image-formed, and the identification information attached to the recording medium, on which the image is already formed, are registered into the data controlling terminal device, by inquiring the presence or absence of the registration of the identification information from the data controlling terminal device, it becomes possible to suppress the injustice use of the recording medium, which is suspended in the mid-course of the image forming operation or failed in the output operation without employing the special paper sheet onto which the ID is attached in advance.

According to another aspect of the present invention, since the data controlling terminal device stores only the identification information with respect to the recording mediums, which succeeded in the output operations, while does not store the identification information allotted to the recording mediums, which are suspended or failed in the output operation, in it, it becomes possible to prevent the recording mediums to be destroyed primarily, which are suspended or failed in the output operation, from being utilized for injustice purposes, while suppressing the amount of data to be stored as the output history.

While the preferred embodiments of the present invention have been described using specific term, such description is for illustrative purpose only, and it is to be understood that changes and variations may be made without departing from the spirit and scope of the appended claims.

What is claimed is:

1. An image forming apparatus for outputting an image, connected with a data management device, comprising:
a data file obtaining section to obtain a data file from the data management device;
an image forming section to form an image on a recording medium based on the data file;.
an identification information generating section to generate identification information corresponding to each recording medium, when the image is formed on the recording medium; and
a transmitting section to transmit the identification information corresponding to the recording medium, an output of which is completed, to the data management device.

2. The image forming apparatus of claim 1,
wherein the transmitting section transmits the identification information to the data management device, when each output of the recording medium where the image is formed based on the data file is completed.

3. The image forming apparatus of claim 2, further comprising:
an canceling section to accept an instruction for canceling an image forming process based on the data file;
wherein request signals for deleting the identification information transmitted prior to a cancellation is transmitted to the data management device, when the instruction is accepted.

4. The image forming apparatus of claim 1,
wherein the transmitting section transmits the identification information to the data management device in accordance with a completion of an image forming job based on the data file.

5. The image forming apparatus of claim 1,
wherein the identification information generating section generates the identification information prior to an image forming process based on the data file.

6. The image forming apparatus of claim 1, further comprising:
a password obtaining section to obtain a password for obtaining the data file from the data management device;
wherein the data file obtaining section obtains the data file in accordance with input of the password.

7. The image forming apparatus of claim 1,
wherein the identification information generating section generates the identification information in accordance with an attribution of the data file.

8. The image forming apparatus of claim 1,
wherein in case that an error is occurred during an image outputting, the identification information corresponding to the recording medium that the error is occurred at the image outputting for is deleted.

9. The image forming apparatus of claim 1,
wherein in case that an error is occurred during an image outputting, new identification information is generated in place of the identification information corresponding to the recording medium that the error is occurred at the image outputting for.

10. The image forming apparatus of claim 1,
wherein an identification information image is formed on each recording medium based on the identification information.

11. The image forming apparatus of claim 1,
wherein date and time information is transmitted with the identification information, the date and time information represents date and time when an image forming process is executed.

12. A data management apparatus connected with an image forming device for outputting an image, comprising:
a data file transmitting section to transmit a data file to the image forming device;
an identification information receiving section to receive identification information corresponding to each recording medium, each output of the recording medium where the image is formed based on the data file is completed; and
a storing section to store the identification information.

13. The data management apparatus of claim 12,
wherein the receiving section receives the identification information from the image forming device, when each output of the recording medium where the image is formed based on the data file is completed.

14. The data management apparatus of claim 13,
wherein request signals for deleting the identification information from the image forming device is received in accordance with a cancellation for an image forming process based on the data file.

15. The data management apparatus of claim 14,
wherein the identification information stored in the storing section is deleted in accordance with a reception of the request signals.

16. The data management apparatus of claim 12,
wherein identification information receiving section receives the identification information from the image forming device in accordance with a completion of an image forming job based on the data file.

17. The data management apparatus of claim 16,
wherein the identification information corresponding to the recording medium that the error is occurred at the image outputting for is not received.

18. The data management apparatus of claim 12, further comprising:
a password transmitting section to transmit a password associated with the data file to the image forming device, wherein the data file transmitting section transmits the data file in accordance with a reception of the password.

19. The data management apparatus of claim 12,
wherein date and time information is received with the identification information, the date and time information represents date and time when an image forming process is executed.

20. The data management apparatus of claim 12, further comprising:
a registration confirmation section to receive an inquiry whether the identification information is registered, check whether the identification information is stored in the storing section, and respond to the inquiry based on a check result.
